(19) United States
(12) Patent Application Publication
(10) Pub. No.: US 2017/0233163 A1
(43) Pub. Date: Aug. 17, 2017

(54) METHOD FOR DELIVERING SIMULTANEOUS DELIVERY OF MULTIPLE COMESTIBLE COMPONENTS IN DIFFERENT STATES

(71) Applicant: Jason Spiegel, Austin, TX (US)

(72) Inventor: Jason Spiegel, Austin, TX (US)

(21) Appl. No.: 15/373,392

(22) Filed: Dec. 8, 2016

Related U.S. Application Data
(63) Continuation-in-part of application No. 13/784,768, filed on Mar. 4, 2013, now abandoned.

(51) Int. Cl. B65D 81/32; A23G 9/00

(52) U.S. Cl. CPC B65D 81/3261; A23G 9/00

(57) ABSTRACT

The present invention provides a method for preparing and delivering a multi-component comestible into a mouth of a consumer. The comestible are stored in separate compartments and combined upon expulsion from the respective compartments.

### CROSS REFERENCE TO RELATED APPLICATIONS

The present application claims the benefit of Ser. No. 13/784,768 filed Mar. 4, 2013 and entitled APPARATUS FOR DELIVERING MULTIPLE COMESTIBLE COMPONENTS IN A SIMULTANEOUS AND ORGANOLEPTICALLY PLEASING MANNER, the contents of which are relied upon and incorporated herein by reference.

### FIELD OF THE INVENTION

The present invention relates generally to simultaneously dispensing two or more comestibles with at least two of the comestibles being dispensed in a different state. In a preferred embodiment of the present invention, a comestible including a frozen confection containing separate components of alcohol and flavored ice is delivered directly into a consumer's mouth.

### BACKGROUND OF THE INVENTION

Since its creation in 1905, the ice-pop has become widely popular, and today, is enjoyed by people of all ages. The first ice-pop was created by Frank Epperson, who accidentally left a glass containing soda powder and water on his back porch with a stirring stick still in it. Overnight, the contents of the glass froze, and Epperson realized he could eat the frozen confection using the stick as a handle. Seventeen years later, the “Eppsicle” was patented (U.S. Pat. No. 1,505,592 to Epperson, et. al.), and soon brought to the commercial market.

In today's market, one can find many variations on the ice-pop, and advancements have broadened the confection's appeal to consumers. A quick stroll through the frozen food section of most grocery stores would reveal ice-pops that are multi-colored, low-fat, low-calorie, multi-flavored, contain real fruit, have no stick, etc.

One such variation on the ice-pop, however, has been considerably more difficult to effectively bring to market: ice-pops containing alcohol. Despite the popularity of frozen cocktails ice-pops containing alcohol have hit a few major roadblocks on their path to widespread commercial viability.

The first of these roadblocks stems from the difference between the freezing temperatures of alcohol and water. Consequently freezing a mixture of the two substances is not easily accomplished. Water freezes at 0° C., whereas ethyl alcohol may not freeze until it reaches temperatures of as low as −114° C. (depending on the proof of the alcohol). This is not to say that a mixture of the two substances cannot be frozen together. Patents have been granted protecting methods of freezing mixtures of water and alcohol, accomplished through blending. For example, U.S. Pat. No. 4,790,999 to Ashmont, et. al., describes a method for creation of ready-to-freeze alcoholic beverages by processing a mixture of sugar, alcohol, flavorings and a carboxymethlycellulose stabilizer; U.S. Pat. No. 5,296,51 to Ishida, et. al., describes a method for super cooling sake under highly pressurized conditions; U.S. Pat. App. 10/459,257 to Squicciarini describes a complex method for creating a frozen alcohol and water mixture by adding a drug and a gelling agent to the mixture, all while kept at a precise temperature.

Although several products have taken advantage of these methods and have been introduced to the marketplace, including Parrot Bay® Frozen Cocktails and Snobar® Alcoholic Ice Cream, they seem to have limited commercial viability, primarily due to two more roadblocks encountered when trying to develop these sorts of products: high price and sensory/taste limitations. The complicated blending processes involved with freezing a mixture of water and alcohol results in a product that must be set at a higher price point, alienating price-sensitive portions of the market; similarly, the pre-blending processes create products that poorly simulate the oganoleptic (i.e. sensory/taste) experience of consuming an alcoholic beverage mixed with ice that many consumers enjoy (be it in crushed, cubed, or shaved form-each of which creates different sensory/taste experiences for the consumer).

As such, there remains a need for an alcoholic ice-pop-style confection that is not impractically expensive to produce and purchase, and is also organoleptically pleasing.

### SUMMARY OF THE INVENTION

Accordingly, the present invention provides methods and apparatus for storing multiple comestible substances separately in respective compartments, and delivering the multiple substances simultaneously. In some preferred embodiments, a first compartment encompasses and surrounds a second compartment. Each of the compartments may contain a comestible that is in fluid communication with a portal. Compressive pressure on the two or more compartments causes a first comestible in the first compartment and a second comestible in the second compartment to exit the portal in a combined fashion at a time of exit.

In some preferred embodiments, the first comestible and the second comestible do not mix prior to expulsion from the tube. In addition, in some preferred embodiments, when expulsed, the first comestible may form a desired pattern in relation to the second comestible. The desired pattern may include, for example, one or more of: a first comestible that surrounds the second comestible; a ratio of a volume of a first comestible to a volume of a second comestible, a shape of expulsed first comestible and/or second comestible. Accordingly to the present invention, organoleptic appeal can be greatly influenced by changes to the way that ingredients in a comestible are delivered. For example, in various embodiments, a sensory and taste differences may result by a comestible that is chopped, mixed, pureed and/or liquefied, just as there can be for a beverage served over cubed, crushed, or shaved ice.

Embodiments that include alcoholic ice-pop-style confections, a difference in organoleptic appeal is generated via separately frozen flavored components, and not mixing separate components prior to expulsion from the tube, as well as the difference in organoleptic appeal that comes from one component containing alcohol being surrounded by a frozen flavored component and thus masking the taste of alcohol on all sides. The design of the present invention therefore includes a new delivery method for a comestible with multiple components, stored in a tube or pouch wherein one component surrounds another and the packaging to permit the simultaneous delivery of the multiple components.

Various features, aspects and advantages of the present invention will be set forth, in part, in the description that follows, and other features, aspects and advantages may be learned from producing or using the present invention. It should be apparent that the foregoing general description, as well as the following detailed description, are only exemplary and explanatory, and are not to be viewed as being restrictive of the invention, as claimed.

### BRIEF DESCRIPTION OF THE DRAWINGS

FIG. 1 illustrates a side view of a package that may be used in some implementations of the present invention.

FIGS. 2-3 depict illustrate a top-down view of some implementations of the present invention.

FIGS. 4-5 depict illustrate variations of compartments for control of a comestible in a liquid-state or gelatinous state to provide control over a flow of the comestible from the compartment.

FIG. 6 illustrates method steps that may be taken in some implementations of the present invention.

### DETAILED DESCRIPTION OF THE INVENTION

The present inventions provides methods and associated apparatus for storing two or more comestibles in separate compartments and rendering the comestibles into different physical states. The comestibles in different states are expelled for consumption while still in the different physical states thereby creating a modified organoleptic experience for the consumer. Shapes and ratios of the expelled comestibles may also be controlled as well as an amount of each comestible to be consumed.

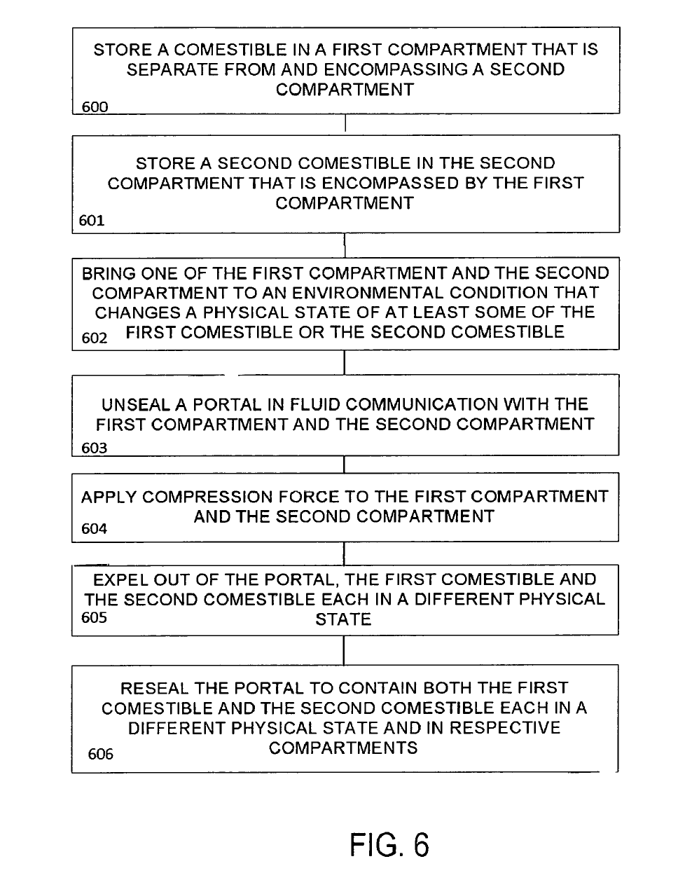

Referring now to FIG. 6, method steps that may be implemented in some embodiments of the present invention are illustrated. At method step 600, a first comestible is stored in a first compartment that is maintained separate from a second compartment. In some embodiments, the first compartment encompasses the second compartment allowing the first comestible to essentially surrounds the second compartment storing a second comestible. Other compartments may also be included and be encompassed or not according to a particular design of an associated package.

At method step 601, a second comestible is stored in a second compartment. In some embodiments, the second compartment and second comestible may be encompassed by the first compartment and the first comestible.

At method step 602, at least one of the first compartment and the second compartment and the corresponding first comestible and second comestible is brought to an environmental condition that changes a physical state of at least the first comestible or the second comestible. The environmental condition may include for example, exposing the compartment to a change in temperature, such as lowering the first compartment or the second compartment to a temperature to a pint at or below a freezing point of the comestible contained within the respective compartment. Relatedly, a change in physical state may include freezing at least some of the first comestible and second comestible into a solid form.

Some preferred embodiments include a first comestible including a flavored aqueous solution being placed into a partially frozen state, wherein the first comestible includes a flowable slurry with frozen solid components mixed with liquid components.

At method step 603, a consumer or other user may unseal a portal. The portal is in fluid communication with both the first compartment and the second compartment (and any additional compartments).

At method step 604, compressive force is applied to both the first compartment and the second compartment and at method step 605, the first comestible and the second comestible are expelled out of the portal, each comestible in a different physical state. In some preferred embodiments, the first comestible includes an aqueous solution in a state of being partially frozen and the second comestible includes an alcoholic solution in a predominantly liquid state.

Still further preferred embodiments include the first comestible essentially surrounding the second comestible such that a consumer of the expelled comestibles will experience the taste of the flavored aqueous solution more than the taste of the alcoholic solution. Other patterns are within the scope of the present invention.

In addition, a ratio of a first comestible and a second comestible may be controlled via a shape of a portal and/or a passage way from one or both of the first compartment and the second compartment to the portal.

At method step 606, portal may be resealed and the first comestible and the second comestible remaining in the first compartment and the second compartment respectively is again retained within the respective compartments.

The method steps may additionally comprise freezing both the first comestible and the second comestible and then thawing at least some of the first comestible and the second comestible to the point where one or both of the first comestible and the second comestible are flowable.

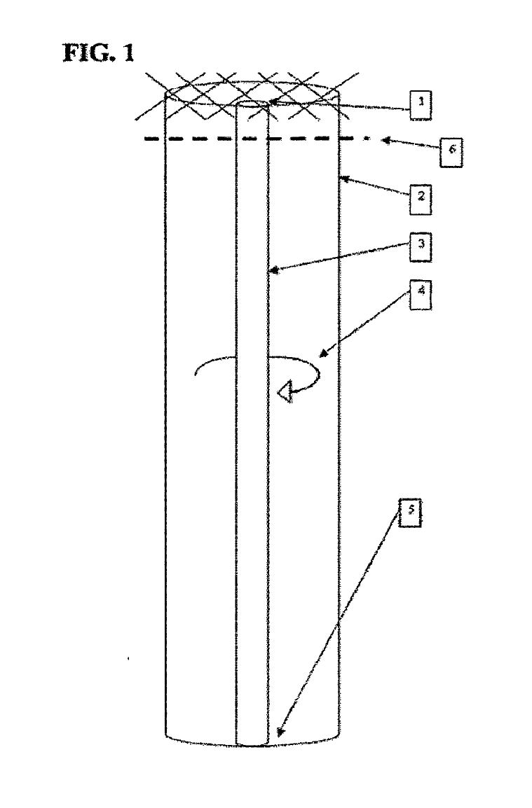

Referring now to FIG. 1, a delivery method for a multi-state or multi-component comestible can be created with a tube or pouch containing within it, another tube(s) or compartment(s).

The outer tube or compartment 2 will have one or more tubes or compartments 3 contained within it, or in other words, the contents of one tube or compartment will be separated from, but surrounded either fully or on multiple sides by, the contents of the other tube(s) or compartment(s). In a preferred embodiment, the entire apparatus will be made of a very thin, highly malleable material (plastic or cellophane, for example). Specifically with reference to an alcoholic ice-pop-style confection, the outer tube or compartment 2 would contain the non-alcoholic portion of the confection, which could be stored at any temperature, but would become a solid or semi-solid when kept at a cold enough temperature. The inner tube 3 (or tubes) would contain the alcoholic portion of the confection, which would remain a liquid, even after being kept at a cold temperature and even after the contents of the outer tube have changed states (liquid to solid or semi solid).

The openings of the tubes will be aligned and sealed together at the top of the apparatus 1. This way, if one were to tear a line 6 across the entire apparatus near the top, all tubes or compartments would be opened, and their contents would all be able to be removed or expelled (i.e. ingested) from a single opening in the apparatus. The bottom of the apparatus 5 would be sealed the same way. As the consumer pushes up on the bottom of the apparatus, or squeezes the apparatus near the bottom, the application of force would push the contents of the apparatus upwards toward the opening 6, and into the consumer's mouth, which would be placed just over that opening.

Because of the fact that one component of the confection would be a liquid, while the other would be a solid or semi-solid, there arises an issue of how to create an even expulsion of the two components of the confection into the consumers mouth. The rate of release of the liquid must be able to be controlled to some extent, for otherwise, the liquid portion of the confection will shoot out too quickly, and the consumer will be served a mouth full of only alcohol-a sensation which will not likely be organoleptically pleasing for that consumer.

The present invention incorporates design modifications, based on composition, texture, viscosity and freezing points of liquid or semi-solid comestible components, that can be made to the apparatus to more precisely control the release of comestible components, in order to further enhance the organoleptic experience for the consumer.

Examples of such modifications include altering the shape and layout of the compartments, the material of the tube, the ingredients in the alcoholic or non-alcoholic components, or the proof of the alcohol. Ways to alter the shape and layout of the compartments are discussed below.

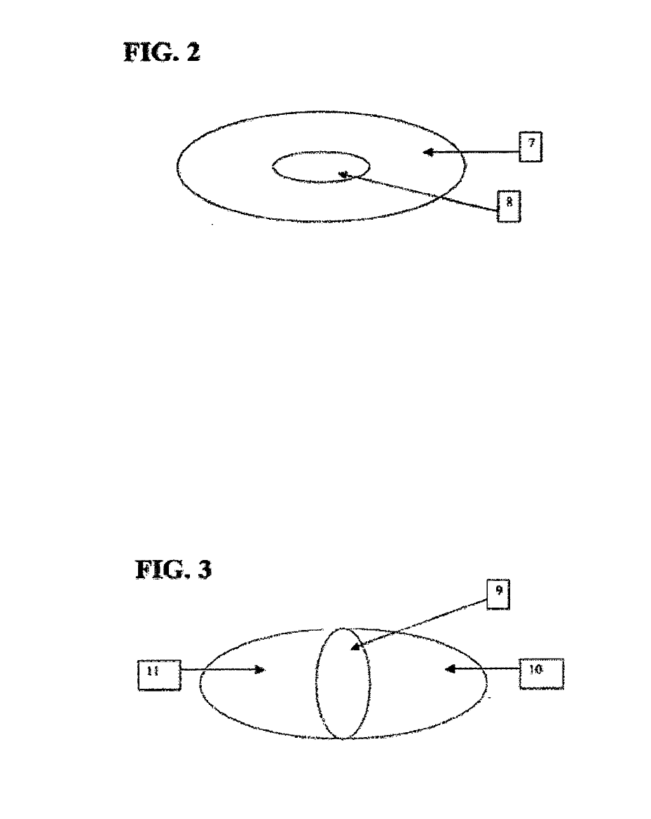

FIG. 2 depicts a top-down view of FIG. 1. As seen in the picture, the larger tube or compartment 2 fully surrounds 4 the smaller tube or compartment 3. The advantage of this layout is that the liquid content of the confection 8 is potentially kept cold longer by the frozen, non-alcoholic outer portion of the confection 7, as it is less exposed to the heat from the consumer's hand. Since alcohol becomes more viscous when its temperature decreases, the rate at which it is expelled from the apparatus can be slowed (i.e., for slower delivery into the consumer's mouth). The tradeoff, however, is that the consumer cannot touch the inner compartment if the center tube is fully surrounded, and therefore has less control over outflow of the liquid.

FIG. 3, in contrast, depicts an alternate layout from the top-down, in which the smaller compartment 9 is wide enough to touch the outside of the apparatus. This effectively creates an additional compartment by splitting the larger, outer compartment into multiple compartments 10 & 11, and adds the benefit of the consumer being able to touch the liquid-filled compartment directly, potentially giving them more control over its expulsion, but also exposing the liquid to more heat from the consumer's hand, and potentially increasing its viscosity.

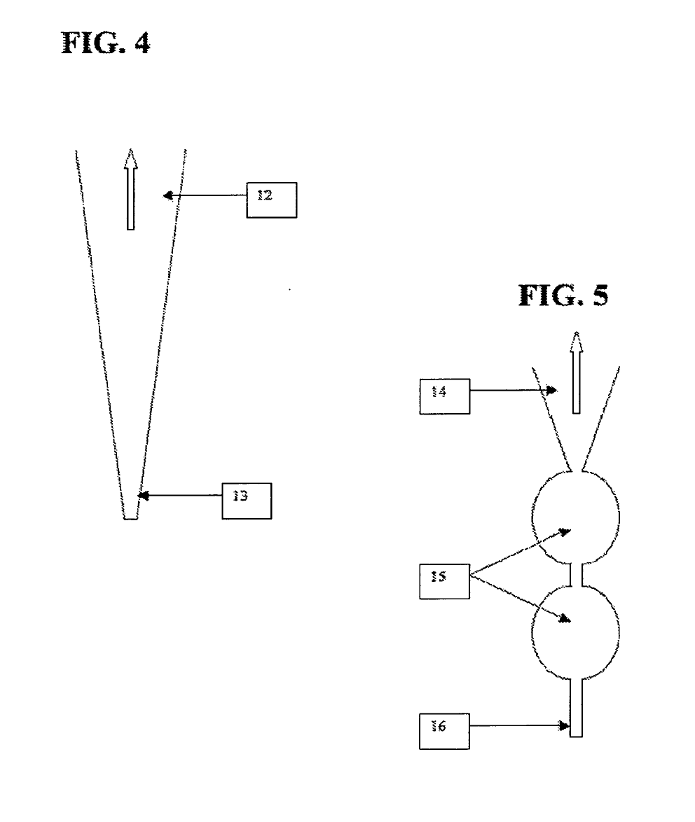

The shape of the compartments can also be modified to control the speed of the release of the liquid portion of the confection. FIG. 1 depicts an inner compartment that is straight 3, however, a true cylinder would likely give the consumer little control over the liquid contents of the compartment. The rate at which liquid will emerge from the top of a compartment when pressure is applied at the bottom depends on the ratio of areas between those two points of the compartment. In a cylinder, like the one depicted in FIG. 1, the ratio of areas of the bottom and top is 1:1, resulting in average control of the liquid's expulsion. On the other hand, if the ratio of areas of the bottom and top were 1:5, you would have to apply five times more force at the bottom to get the same amount of liquid to come out of the top. FIG. 4 depicts an example of a compartment with a ratio of areas that would give the consumer more control over the flow of the liquid from the top of the compartment. The area at the bottom of the compartment 13 is small, but the area at the top of the compartment 12 is larger, so the liquid would flow from the top at a slower rate than it would in a compartment with a 1:1 ratio (the true cylinder) if the same amount of force were to be applied to the bottom. FIG. 5 depicts another such modification that can be made. Like FIG. 4, the ratio of areas of the bottom to the top still gives more control over the expulsion of liquid from the top, since the top 14 has a greater area than the bottom 16. However, this compartment has two sub-compartments 15, which could give the consumer even greater control over how the liquid is displaced.

The present invention aims not only to deliver both phases of a multi-state or multi-component comestible in a simultaneous fashion, but also to do so in an organoleptically pleasing manner best suited to the composition of the comestibles being delivered to the consumer's mouth. Experimentation with modifications to the apparatus is necessary for development of an apparatus that provides the most enjoyable consumption experience possible for a given comestible.

While the invention has been described in connection with one or more embodiments, it is to be understood that the specific designs that have been described are merely illustrative of the principles of the invention. Numerous modifications may be made to the design of the apparatus without departing from the spirit and scope of the invention as defined by the appended claims.

What is claimed is:

1. A method for dispensing two or more comestibles in different physical states, the method comprising:
storing a comestible in a first compartment that is separate from and encompassing a second compartment;
storing the second comestible in a second compartment that is surrounded by the first compartment;
bringing at least one of the first compartment and the second compartment into an environmental condition that changes a physical state of a least some of one or both of the first comestible and the second comestible;
unsealing a portal in fluid communication with the first compartment and the second compartment;
applying compression force to both the first compartment and the second compartment;
expelling both the first comestible and the second comestible from the portal with at least one of the first comestible and the second comestible in the changed physical state; and
combining the first comestible and the second comestible.
